(19) United States
(12) Patent Application Publication
(10) Pub. No.: US 2016/0292686 A1
(43) Pub. Date: Oct. 6, 2016

(54) AUTHENTICATION SYSTEMS AND METHODS FOR CREDENTIAL ACTIVATION AND PROVISIONING

(71) Applicants: Prasanna Laxminarayanan, San Ramon, CA (US); Simon Law, San Mateo, CA (US); Anjana Surin, Foster City, CA (US); Erick Wong, Menlo Park, CA (US)

(72) Inventors: Prasanna Laxminarayanan, San Ramon, CA (US); Simon Law, San Mateo, CA (US); Anjana Surin, Foster City, CA (US); Erick Wong, Menlo Park, CA (US)

(21) Appl. No.: 15/087,054

(22) Filed: Mar. 31, 2016

Related U.S. Application Data
(60) Provisional application No. 62/141,204, filed on Mar. 31, 2015.
(60) Provisional application No. 62/171,808, filed on Jun. 5, 2015.

(51) Int. Cl. G06Q 20/40; H04L 29/06

(52) U.S. Cl. CPC G06Q 20/4014; H04L 63/102

(57) ABSTRACT

Authentication systems and methods are provided for credential activation and/or provisioning. A transaction is made by a transaction processor to a user's credential account that contains a value and an activation code. The user retrieves the activation code from his or her account and provides it to the transaction processor. If the activation codes match, the credential may be activated.

### CROSS-REFERENCE TO RELATED APPLICATIONS

This application claims priority to U.S. Provisional Patent Application No. 62/141,204, filed Mar. 31, 2015, and U.S. Provisional Patent Application No. 62/171,808, filed Jun. 5, 2015, which are herein incorporated by reference in their entireties.

### BACKGROUND

To perform a transaction such as a purchase, a bill payment, a money transfer, or activation of a new account, a user typically provides his or her account number. Authentication processes may be performed to verify the account number and to verify that the user is authorized to perform financial transactions on the account. One method of authenticating a user for an account posts a transaction for a random amount to the account. To verify the account, the user retrieves the random amount from his or her account statement and provides the random amount to the authenticating party. If the values match, the user is authenticated to perform financial transactions using that account.

However, many disadvantages are associated with this method of authentication. For example, only a finite number of random amounts are practical. Because the transaction is debiting or crediting the account, only low value transactions can be performed at a low cost to the user or the authenticator. Thus, the random amount may be easily guessed by a malicious third party trying to access the account.

### SUMMARY

There is a need for new and enhanced systems and methods of authentication for credential activation and provisioning. Embodiments of the invention address these and other problems, individually and collectively. Embodiments of the invention are directed to systems and methods related to authenticating users prior to activating credentials, provisioning a device with credentials, or otherwise allowing access to a restricted resource. Embodiments of the invention utilize an activation code in the merchant descriptor field of a transaction to verify a credential, providing countless combinations of letters, numbers and/or symbols that may not easily be guessed by a malicious third party.

One embodiment of the invention is directed to method comprising receiving a request to activate a credential. The credential allows access to a resource by a user. The method further comprises performing a first authentication process of the user, determining that a second authentication process of the user is necessary, and performing the second authentication process of the user. The second authentication process comprises generating an authorization request message comprising a value and an activation code, sending the authorization request message to an authorizing entity computer associated with the credential, receiving an authorization response message approving of the authorization request message, sending a notification message notifying the user to retrieve the activation code, receiving the activation code, and determining that the received activation code matches the generated activation code. After performing the second authentication process of the user, the credential is activated.

Another embodiment of the invention is directed to a server computer comprising a processor and a memory element comprising code, executable by the processor, for implementing the above method.

These and other embodiments of the invention are described in further detail below.

### BRIEF DESCRIPTION OF THE DRAWINGS

FIG. 1 shows a block diagram of an authentication system for credential activation and provisioning according to an embodiment of the present invention.

FIG. 2 shows a flow diagram of an authentication method for credential activation and provisioning according to an embodiment of the present invention.

FIG. 3 shows a flow diagram of an authentication method for token generation and provisioning according to an embodiment of the present invention.

FIG. 4A shows a screen shot of authentication options available to a user according to an embodiment of the present invention.

FIG. 4B shows a screen shot of terms of service for using an authentication system according to an embodiment of the present invention.

FIG. 4C shows a screen shot of a notification message notifying a user to retrieve an activation code according to an embodiment of the present invention.

FIG. 4D shows a screen shot of a log-in website associated with a credential according to an embodiment of the present invention.

FIG. 4E shows a screen shot of transactions made with a credential, including a transaction with an activation code, according to an embodiment of the present invention.

FIG. 4F shows a screen shot of a user interface for entering an activation code according to an embodiment of the present invention.

FIG. 5 shows a block diagram of a transaction processing computer according to an embodiment of the present invention.

FIG. 6 shows a block diagram of a transaction system for using an activated and/or provisioned credential according to an embodiment of the present invention.

FIG. 7 shows a block diagram of a building access system for using an activated and/or provisioned credential according to an embodiment of the present invention.

### DETAILED DESCRIPTION

Embodiments of the present invention are directed to systems and methods related to authenticating users prior to activating credentials or provisioning the portable devices with credentials. Prior to discussing specific embodiments of the invention, it may be helpful to discuss some specific terms.

An “activation code” may be any combination of letters, numbers and/or symbols, and of any length, which can be used to activate or provision something. For example, an activation code may be used to activate or provision a credential.

An “authentication process” may be any process of confirming that an entity (e.g., a user, a device, etc.) is who or what it claims to be. Exemplary authentication processes include biometric authentication (e.g., retina scan, fingerprint scan, etc.), knowledge-based authentication (e.g., prompting a user to answer personal questions that only he or she would be likely to know the answers to), user verification of a transaction, location-based authentication (e.g., matching a device IP address to a location, comparing device location to merchant location, etc.), call center authentication, and the like.

An “authorizing entity” may be an entity that authorizes a transaction or request. Examples of an authorizing entity may be an issuer, a governmental agency, a document repository, an access administrator, etc.

An “authorization request message” may be an electronic message that is sent to an authorization system such as a payment processing network and/or an issuer computer to request authorization for a transaction. An authorization request message is an example of a transaction message. An authorization request message according to some embodiments may comply with ISO 8583, which is a standard for systems that exchange electronic transaction information associated with a payment made by a consumer using a payment device or a payment account. The authorization request message may comprise a primary account number (PAN), expiration date, service code, CVV and other data from a payment device. In some embodiments of the invention, an authorization request message may include a payment token (e.g., a substitute or pseudo account number), an expiration date, a token presentment mode, a token requestor identifier, an application cryptogram, and an assurance level data. The payment token may include a payment token issuer identifier that may be a substitute for a real issuer identifier for an issuer. For example, the real issuer identifier may be part of a BIN range associated with the issuer. An authorization request message may also comprise additional data elements corresponding to “identification information” including, by way of example only: a service code, a CVV (card verification value), a dCVV (dynamic card verification value), an expiration date, etc.

An “authorization response message” may be an electronic message reply to an authorization request message generated by the authorization system. The authorization response message may include an authorization code, which may be a code that the authorization system returns in response to receiving an authorization request message (either directly or through the payment processing network). The authorization response message is received at the merchant's access device (e.g. POS terminal) and can indicate approval or disapproval of the transaction by the authorization system.

A “communication device” may be a device that includes one or more electronic components (e.g., an integrated chip) that can communicate with another device. A “portable communication device” may be one form of a communication device that can be transported and operated by a user. A portable communication device may provide remote communication capabilities to a network, and can be configured to transmit and receive data or communications to and from other devices. A portable communication device may be in the form of a mobile device such as a mobile phone (e.g., smart phone, cellular phone, etc.), tablets, portable media player, personal digital assistant devices (PDAs), wearable computing device (e.g., watch), electronic reader device, etc., or in the form of a card (e.g., smart card) or a fob, etc. Examples of portable communication devices may also include portable computing devices (e.g., laptop, netbook, ultrabook, etc.). A portable communication device may also be in the form of a vehicle (e.g., an automobile such as car) equipped with communication and/or network connectivity capabilities.

“Contactless” or “wireless” can include any communication method or protocol, including proprietary protocols, in which data is exchanged between two devices without the need for the two devices to be physically coupled. For example, “contactless” or “wireless” can include radio frequency (RF), infrared, laser, or any other communication means, and the use of any protocols, such as proprietary protocols, with such communication means.

A “credential” may comprise any evidence of authority, rights, or entitlement to privileges, such as access to a resource. For example, access credentials may comprise permissions to access certain tangible or intangible assets, such as a building or a file. In another example, payment credentials may include any suitable information associated with and/or identifying an account (e.g., a payment account and/or payment device associated with the account). Such information may be directly related to the account or may be derived from information related to the account. Examples of account information may include an “account identifier” such as a PAN (primary account number or “account number”), a token, a subtoken, a gift card number or code, a prepaid card number or code, a user name, an expiration date, a CVV (card verification value), a dCVV (dynamic card verification value), a CVV2 (card verification value 2), a CVC3 card verification value, etc. An example of a PAN is a 16-digit number, such as “4147 0900 0000 1234”. In some embodiments, credentials may be considered sensitive information.

A “notification message” may include any communication from one party or entity to another party or entity. The communication may include, for example, information or data in any suitable form. Further, the message may be transmitted by any suitable method such as, for example, over a network.

“Provisioning” may include a process of providing data for use. For example, provisioning may include providing, delivering, or enabling a token on a communication device. Provisioning may be completed by any entity within or external to the transaction system. For example, in some embodiments, tokens may be provisioned by an issuer or a transaction processing network onto a mobile device. The provisioned tokens may have corresponding token data stored and maintained in a token vault or token registry. In some embodiments, a token vault or token registry may generate a token that may then be provisioned or delivered to a device. In some embodiments, an issuer may specify a token range from which token generation and provisioning can occur. Further, in some embodiments, an issuer may generate and notify a token vault of a token value and provide the token record information (e.g., token attributes) for storage in the token vault.

A “resource” is any tangible or intangible asset. Exemplary resources include money, a building, a room, a device, a file, an application, an account, data, and the like.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “token” may be a substitute for sensitive information. A token may refer to information that can be transmitted or use in place of the sensitive information. For example, a token can be a substitute for sensitive information such as a real account identifier, and the token may be used in place of the real account identifier to conduct access the account. In the payment context, a payment token may be an identifier for a payment account and act as a substitute for the real account identifier (e.g., a primary account number (PAN)). A token may include a series of alphanumeric characters that may be used as a substitute for an original account identifier. For example, a token “4900 0000 0000 0001” may be used in place of a primary account number (PAN) “4147 0900 0000 1234.” In some embodiments, a token may be format preserving and may have a numeric format that conforms to the account identifiers used in existing payment processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token can be generated in a manner such that the recovery of the original sensitive information (e.g., PAN) may not be algorithmically or computationally derived. For example, a token may include random numbers so that the PAN associated with the token is not computationally derivable from the token. A lookup table may be used to associate a PAN and a corresponding token. In some embodiments, a token can be a non-payment token that is used as a substitute for other types of sensitive information.

A “virtual wallet” or “digital wallet” may refer to an electronic device that allows an individual to make electronic commerce transactions. This can include purchasing items on-line with a computer or using a communication device (e.g., smartphone) to purchase an item at a physical store. The “virtual wallet” or “digital wallet” can consist of the system (the electronic infrastructure), the application (the software that operates on top), and the device (the individual portion). An individual's bank account can also be linked to the virtual wallet. The individual may also have their driver's license, health card, loyalty card(s), and other ID documents stored within the virtual wallet.

A “virtual wallet provider” or “digital wallet provider” may include any suitable entity that provides a virtual wallet service or digital wallet service. A virtual wallet provider may provide software applications that store account numbers, account numbers including unique identifiers, or representations of the account numbers (e.g., tokens), on behalf of an account holder to facilitate payments at more than one unrelated merchant, perform person-to-person payments, or load financial value into the virtual wallet.

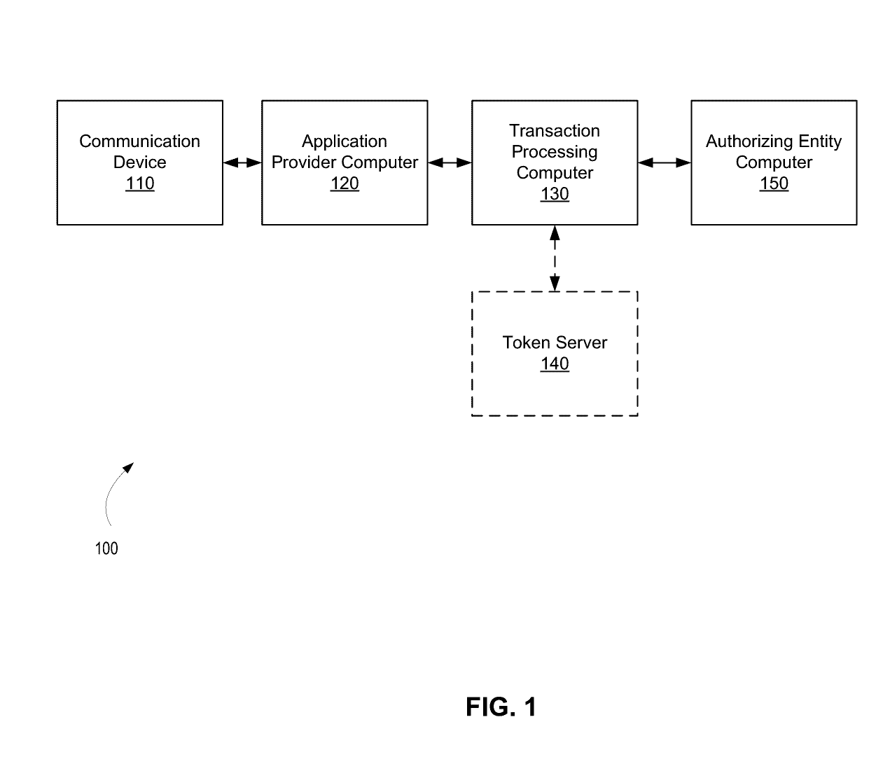

FIG. 1 shows a block diagram of an authentication system 100 for credential activation and provisioning according to an embodiment of the present invention. The system 100 includes a communication device 110 and an application provider computer 120 in communication with the communication device 110. The application provider computer 120 may be in communication with a transaction processing computer 130, which may in turn be in communication with an authorizing entity computer 150 and a token server 140. The communication device 110 may be operated by a user (not shown).

In some embodiments, the communication device 110 may include an application (such as a virtual wallet or payment application) that can be used to activate a credential to enable the communication device 110 to access a resource (e.g., to conduct a transaction at a merchant). In some embodiments, activation of a credential may include provisioning of the credential on the communication device 110. The communication device 110 may further be used to select one or more authentication processes, and to retrieve and enter activation codes associated with credentials. The communication device may optionally include a secure element for securely storing credentials.

The communication device 110 may be in any suitable form. For example, suitable communication devices 110 may be hand-held and compact so that they can fit into a user's pocket. Examples of communication devices 110 may include any device capable of accessing the Internet. Specific examples of communication devices 110 include cellular or wireless phones (e.g., smartphones), tablet phones, tablet computers, laptop computers, desktop computers, personal digital assistants (PDAs), pagers, portable computers, smart cards, and the like. Additional communication devices 110 may also include wearable devices, such as smart watches, fitness bands, ankle bracelets, rings, earrings, etc. Other examples of communication devices may include vehicles such as automobiles with remote communication capabilities.

The communication device 110 may include a processor, memory, input/output devices, and a computer readable medium coupled to the processor. The computer readable medium may comprise code, executable by the processor for performing the functionality described herein. In some embodiments, the communication device 110 may include a browser and/or applications (e.g., mobile applications, computer programs, etc.) stored in the memory and configured to retrieve, present, and send data across a communications network (e.g., the Internet).

The application provider computer 120 may provide an application installed on communication device 110 that may be used to perform authentication processes, to request activation and/or provisioning of a credential on communication device 110, and to initiate transactions using a credential. The application provided by application provider computer 120 may further be used to perform transactions with the credential (e.g., to request access to a resource). In one example, the application provider computer 120 is a virtual wallet provider. In some embodiments, the application provider computer 120 may be combined with the authorizing entity computer 150. For example, an issuer may be both an authorizing entity and an application provider.

In one embodiment, the application provider computer 120 is a token requestor. A token requestor may be an entity or device that requests a token. For example, a token requestor may initiate a token generation process by sending a request that a PAN be tokenized to a token server 140. The token requestor may include any application, device, or system that is configured to request a token and/or initiate a transaction with a token. For example, a token requestor can request registration with a token server, token generation, token activation, token de-activation, token exchange, other token lifecycle management related processes, and/or any other token related processes. A requestor may interface with token server 140 through any suitable communication networks and/or protocols (e.g., using HTTPS, SOAP, and/or an XML interface, among others), either directly or indirectly (e.g., through transaction processing computer 130).

Some non-limiting examples of token requestors may include, for example, resource providers, transport computers, transport computer processors, payment gateways acting on behalf of resource providers, payment enablers (e.g., original equipment manufacturers, mobile networks operators, etc.), virtual wallet providers, authorizing entities, and/or transaction processing computers. In some embodiments, a token request may request tokens for multiple domains and/or channels. A token requestor may be registered and identified uniquely by the token server 140 within the tokenization ecosystem.

The application provider computer 120 may be comprised of various modules that may be embodied by computer code, residing on computer readable media. The application provider computer 120 may include a processor and a computer readable medium coupled to the processor, the computer readable medium comprising code, executable by the processor for performing the functionality described herein.

The transaction processing computer 130 may comprise systems that enable generation of an activation code, which may be considered a one-time password. In some implementations, the activation code may be any combination of letters, numbers, and/or symbols (e.g., a six digit number). The transaction processing computer 130 may include data processing subsystems, networks, and operations used to support and deliver authorization services, exception file services, and clearing and settlement services. An exemplary transaction processing computer 130 may include VisaNet™. Networks that include VisaNet™ are able to process credit card transactions, debit card transactions, and other types of commercial transactions. VisaNet™, in particular, includes an integrated payments system that processes authorization requests and a Base II system that performs clearing and settlement services. The transaction processing computer 130 may use any suitable wired or wireless network, including the Internet.

The transaction processing computer 130 may comprise a server computer. The server computer may include a processor and a computer readable medium coupled to the processor, the computer readable medium comprising code, executable by the processor. In some embodiments, the server computer may be coupled to a database and may include any hardware, software, other logic, or any combination of the preceding for servicing the requests from one or more client computers.

The optional token server 140 may provide services, including but not limited to a token service module that can generate, provide, activate, and/or maintain a token. It may also store PAN to token mappings. In some embodiments, the functions and modules of the token server 140 are incorporated in the transaction processing computer 130. In embodiments in which tokens are not used as credentials, token server 140 may be unnecessary. The token server 140 may include a processor and a computer readable medium coupled to the processor, the computer readable medium comprising code, executable by the processor.

The authorizing entity computer 150 may be associated with an authorizing entity, such as an issuer (e.g., a bank). In an embodiment in which the authorizing entity is an issuer, the authorizing entity computer 150 may maintain financial accounts for the user of the communication device 110, and can issue payment devices, such as credit or debit cards to the user of the communication device 110. When a transaction involves a credential associated with the authorizing entity computer 150, authorizing entity computer 150 may verify the credential and respond with an authorization response message, as described further herein. In some embodiments, the authorizing entity computer 150 may manage a mobile banking or online service with which a user of communication device 110 may have an account. In some cases, services of authorizing entity computer 150 may be accessed by a website. Authorizing entity computer 150 may be in communication with the communication device 110 by a communications network, which may allow a user to access the mobile or online services hosted by authorizing entity computer 150. In some embodiments, the application provider computer 120 may be combined with the authorizing entity computer 150. The authorizing entity computer 150 may include a processor and a computer readable medium coupled to the processor, the computer readable medium comprising code, executable by the processor.

A communications network may comprise a plurality of networks for secure communication of data and information between entities. In some embodiments, the communications network may follow a suitable communication protocol to generate one or more secure communication channels. Any suitable communications protocol may be used for generating a communications channel. A communications channel may in some instances comprise a “secure communication channel”, which may be established in any known manner, including the use of mutual authentication and a session key and establishment of an SSL session. However, any method of creating a secure channel may be used. By establishing a secure channel, sensitive information (such as credentials) may be securely transmitted.

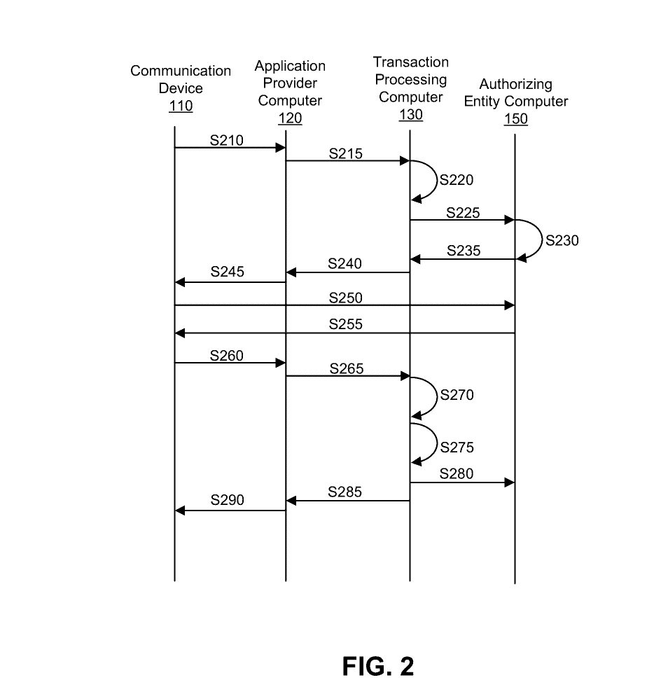

FIG. 2 shows a flow diagram of an authentication method for credential activation and provisioning according to an embodiment of the present invention. At step S210, a user associated with communication device 110 submits a request to application provider computer 120 to activate a credential. In some embodiments, activating the credential includes provisioning the credential onto communication device 110. The credential may any credential that allows access to a resource by a user, such as, for example, a PAN or a token. The user may have previously or concurrently enrolled with the application provider computer 120.

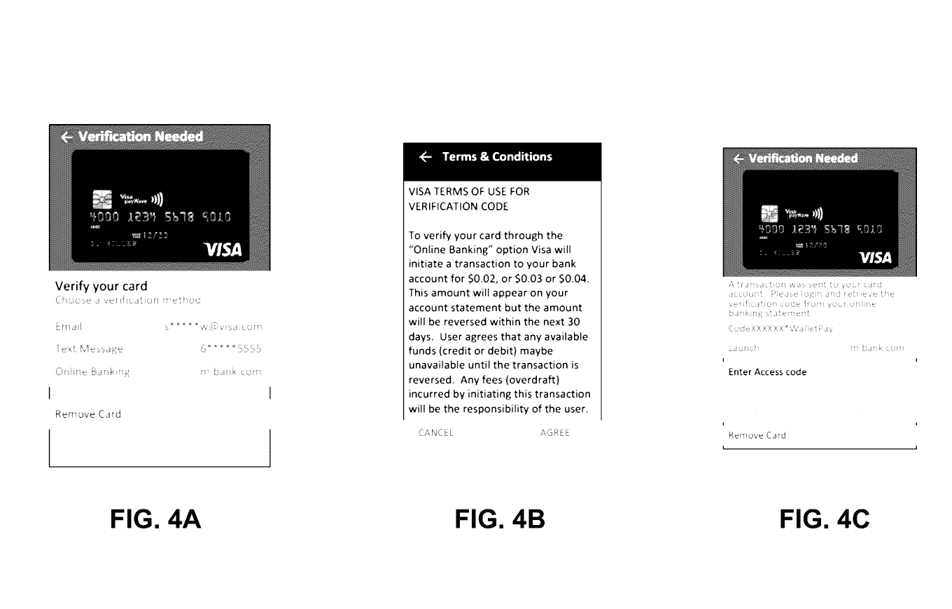

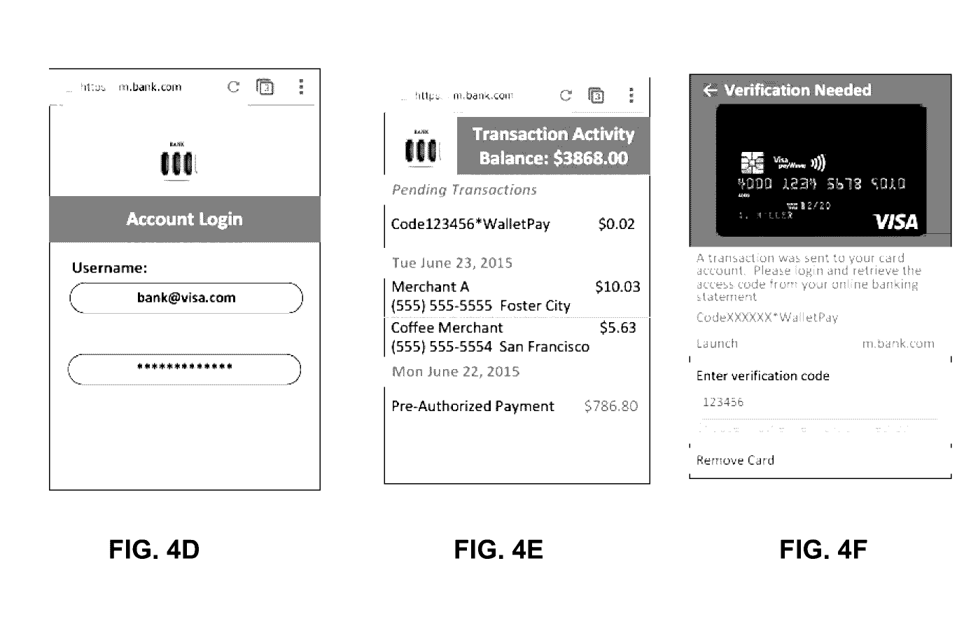

Further, the request may include a user selection to verify his or her identity and credential information by receiving an activation code posted to his or her account. The user selection may be made via a user interface in the application associated with application provider computer 120. FIG. 4A shows an exemplary screen shot of a user interface displaying authentication options available to a user. In this example, the “Online Banking” option would be selected to verify the credential by receiving an activation code. Once the authentication method is selected, the user may agree to Terms & Conditions for receiving the activation code, as shown in FIG. 4B.

Turning back to FIG. 2, at step S215, the application provider computer 120 forwards the request to transaction processing computer 130. At step S220, the transaction processing computer 130 generates an activation code. The activation code may be any combination of letters, numbers, and/or symbols of any length, and can be generated randomly, according to a formula or algorithm, or according to any method.

The activation code can be generated in any suitable manner. For example, the activation code can be generated randomly, pseudo-randomly, or systematically. Activation codes may be generated using different seeds provided by different entities (e.g., different banks) that are associated with those activation codes.

The activation code may be associated with a time limit (e.g., 24 or 48 hours) during which it is valid. If the activation code is attempted to be used after that time limit, it will have expired. The activation code may further be associated with a maximum number of attempts. For example, if the activation code is associated with one attempt, the user will have one attempt to enter the correct activation code, or else the activation code will expire and a new activation code will have to be generated.

The transaction processing computer 130 then generates an authorization request message comprising a value (e.g., $0.04) and the activation code (e.g., DJFG34). The authorization request message may comprise any transaction amount, which may be a random value between $0.01 and $0.10 (or any other suitable range). In one embodiment, the authorization request message is only for preauthorization, such that the transaction never clears to the credential account (i.e., it remains pending for a certain amount of time before expiration, and the value is never credited or debited). In another embodiment, the authorization request message may allow the transaction to clear to the credential account (i.e., to post a credit or debit to the account), and a reversal can be used after the credential is activated.

The transaction type indicator in the authorization request message may be “credit”, “debit”, or “prepaid”, depending on the type of transaction. In the case of a credit transaction, a 0100 or an original credit transaction (OCT) message may be used to effect the credit, for example.

The merchant descriptor may be “<wallet>activation:<xxxxxx>”, where <wallet>can be the name of the application provider computer 120, and xxxxxx may represent a six-digit unique activation code. The merchant identification indicator may indicate either the application provider computer 120 or the transaction processing computer 130, for example, so the user may easily identify the party submitting the request.

The acquirer BIN in the authorization request message may be a number or code unique to the particular type of authentication described herein, such that an authorizing entity can easily identify these transactions as being part of this authentication process. In some embodiments, the authorization request message may also comprise a real primary account number or PAN associated with the user. The PAN may have been received from the application provider computer 120. It may have alternatively been stored in the transaction processing computer 130, and may have been retrieved in response to receiving an alias (e.g., a phone number or digital wallet ID) from the application provider computer 120.

The transaction processing computer 130 may further determine which authorizing entity is associated with the credential. At step S225, the transaction processing computer 130 may forward the authorization request message to the proper authorizing entity computer 150.

At step S230, the authorizing entity computer 150 processes the authorization request message by, for example, determining whether sufficient funds are available. The authorizing entity computer 150 then generates an authorization response message approving or denying the authorization request message, posts the transaction to the account associated with the credential if the request is approved, and sends the authorization response message back to the transaction processing computer 130 at step S235. The posting of this transaction will occur with a number of other normal transactions conducted by the user using the account. In some embodiments, at some point later, a clearing and settlement process occurs for the transaction. In these embodiments, the transaction may be later reversed, such that no net change in value is made to the account. In other embodiments, a clearing and settlement process does not occur, such as, for example, when the authorization request message is only for preauthorization.

At step S240, the transaction processing computer 130 determines the proper application provider from the authorization response message, and sends a notification message to application provider computer 120. The application provider computer 120 sends the notification message to the communication device 110 at step S245. The notification message notifies the user of the communication device 110 that a transaction including an activation code has been posted to the user's account. An exemplary notification message is shown in FIG. 4C: “A transaction was sent to your card account. Please login and retrieve the verification code from your online banking statement.”

Turning back to FIG. 2, at step S250, the user accesses the online account associated with the credential (either using communication device 110 or another device). In this embodiment, the credential is maintained by the authorizing entity computer 150. For example, the user may enter his or her registered user name and password on a website associated with the authorizing entity computer 150. FIG. 4D shows an exemplary account log-in website associated with an authorizing entity.

Turning back to FIG. 2, at step S255, the authorizing entity computer 150 allows the user to view any or all of the transactions associated with the credential, including the transaction with the value and the activation code. FIG. 4E shows a screen shot of a user interface for viewing transactions associated with a credential. The first pending transaction in FIG. 4E illustrates the transaction having the activation code: “Code123456*WalletPay $0.02”. In this example, the activation code is “123456”.

Turning back to FIG. 2, at step S260, the user enters the retrieved activation code (either onto communication device 110 or on another device) to send to application provider computer 120. In one embodiment, the user also enters the value of the transaction. FIG. 4F illustrates an exemplary user interface for entering an activation code. In this example, the user has entered the activation code of “123456” in the proper field.

Turning back to FIG. 2, at step S265, application provider computer 120 sends the user-entered activation code (and optionally the value) to the transaction processing computer 130. At step S270, the transaction processing computer 130 compares the received activation code to the activation code generated at step S220 (and optionally, the values). In one embodiment, the transaction processing computer 130 determines whether it received the activation code within a prescribed time limit (e.g., 24 or 48 hours).

At step S275, the transaction processing computer 130 activates the credential if the activation codes (and optionally, the values) match. Activation of the credential can occur in any suitable manner. For example, if the credential is a token, an inactivated token may be present on the communication device 110 and a signal may be sent to the communication device 110 to turn it into an active state. In another embodiment, the token may be activated by altering data at the transaction processing computer 130 indicating that the token can now be processed. In yet another embodiment, activation can include provisioning the token to the communication device 110 by the transaction processing computer 130.

Once the credential is activated, it may be used to access a resource by the user. For example, in the case of a payment credential, it may be used to conduct transactions (i.e., it will be accepted by transaction processing computer 130 and/or authorizing entity computer 150 to perform transactions).

At step S280, the transaction processing computer 130 notifies the authorizing entity computer 150 associated with the credential that the credential has been activated and may be used. At step S285, the transaction processing computer 130 notifies the application provider computer 120 that the credential was activated, and optionally provides the credential to the application provider computer 120 if the credential is to be provisioned on the communication device 110. At step S290, the application provider computer 120 notifies the communication device 110 that the credential is activated, and optionally provides the credential to the communication device 110 if the credential is to be provisioned on the communication device 110 (e.g., if the credential has not previously been provisioned and/or if the user wants to perform contactless transactions using communication device 110).

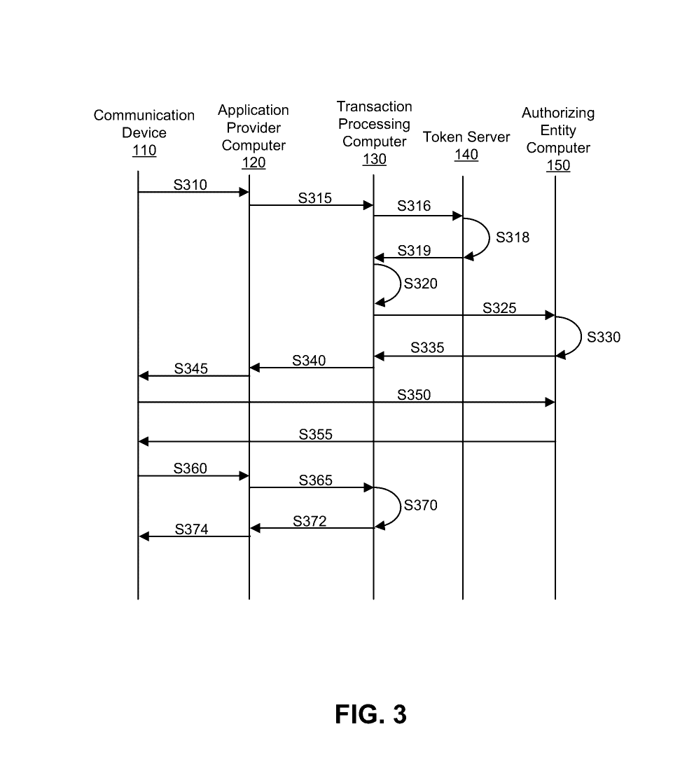

FIG. 3 shows a flow diagram of an authentication method for token generation and provisioning according to an embodiment of the present invention. FIG. 3 is similar to FIG. 2; however, in the method illustrated by FIG. 3, a token is described as the credential, and is requested, generated, and provisioned onto communication device 110.

At step S310, a user associated with communication device 110 submits a request to application provider computer 120 to generate and activate (e.g., provision) a token onto communication device 110. The request may include a primary account number (PAN). The user may have previously or concurrently enrolled with the application provider computer 120. Further, the request may include a user selection to verify his or her identity and credential information by receiving an activation code posted to his or her account associated with the PAN.

At step S315, the application provider computer 120 forwards the request to transaction processing computer 130. At step S316, the application provider computer 120 forwards the request to token server 140. At step S318, token server 140 generates a token associated with the PAN, and sends the token back to the transaction processing computer 130 at step S319.

At step S320, the transaction processing computer 130 generates an activation code. The activation code may be any combination of letters, numbers, and/or symbols of any length, and can be generated randomly, according to a formula or algorithm, or according to any method. The activation code may be associated with a time limit (e.g., 24 or 48 hours) during which it is valid. If the activation code is attempted to be used after that time limit, it will have expired. Logic in the transaction processing computer 130 may be such that the activation code will not be accepted or processed if it is submitted outside of any prescribed time limit.

The transaction processing computer 130 then generates an authorization request message comprising a value (e.g., $0.04) and the activation code (e.g., DJFG34). The authorization request message may comprise any transaction amount, which may be a random value between $0.01 and $0.10 (or any other suitable range). In some embodiments, the authorization request message may also comprise the PAN.

The transaction processing computer 130 may further determine which authorizing entity is associated with the PAN. At step S325, the transaction processing computer 130 may forward the authorization request message to the proper authorizing entity computer 150.

At step S330, the authorizing entity computer 150 processes the authorization request message by, for example, determining whether sufficient funds are available. The authorizing entity computer 150 then generates an authorization response message approving or denying the authorization request message, posts the transaction to the account associated with the PAN if the request is approved, and sends the authorization response message back to the transaction processing computer 130 at step S335.

At step S340, the transaction processing computer 130 determines the proper application provider from the authorization response message, and sends a notification message to application provider computer 120. The application provider computer 120 sends the notification message to the communication device 110 at step S345. The notification message notifies the user of the communication device 110 that a transaction including an activation code has been posted to the user's account.

At step S350, the user accesses the online account associated with the PAN (either using communication device 110 or another device). In this embodiment, the account associated with the PAN is maintained by the authorizing entity computer 150. For example, the user may enter his or her registered user name and password on a website associated with the authorizing entity computer 150. At step S355, the authorizing entity computer 150 allows the user to view any or all of the transactions associated with the PAN, including the transaction with the value and the activation code.

At step S360, the user enters the retrieved activation code (either onto communication device 110 or on another device) to send to application provider computer 120. In one embodiment, the user also enters the value of the transaction. At step S365, application provider computer 120 sends the user-entered activation code (and optionally the value) to the transaction processing computer 130. At step S370, the transaction processing computer 130 compares the received activation code to the activation code generated at step S320 (and optionally, the values). In one embodiment, the transaction processing computer 130 determines whether it received the activation code within a prescribed time limit (e.g., 24 or 48 hours).

At step S372, the transaction processing computer 130 provides the token to the application provider computer 120. At step S374, the application provider computer 120 provides the token to the communication device 110. The token can be installed on the application on communication device 110, and can be used to perform contactless transactions as a substitute for the PAN using the application.

Although shown and described in FIGS. 2 and 3 as being a first line authentication process, it is contemplated that the methods described in FIGS. 2 and 3 can be performed as a subsequent (e.g., second or later) authentication process, if deemed necessary. For example, a different, first authentication process may be performed of the user by any of the entities shown in FIG. 1 that may indicate high risk associated with the user or credential. The methods described in FIGS. 2 and/or 3 may then be performed as a “step up” authentication procedure to further verify his or her identity and authorization to access the credential.

Although requiring more effort than providing a PIN or password, the methods described herein may be desirable as a second, “step up” authentication procedure because they provide greater assurance that the user is authorized to use the underlying account than a simpler method of authentication. For example, the methods described herein require that the user be able to log in and access an account with an associated authorizing entity, and in some embodiments, in a short period of time. This reduces the risk that a hacker or unauthorized party are able to retrieve the activation code from the authorizing entity, even if they are able to request generation of an activation code from the application provider, because the log-in information for the accounts may be different. Further, the unauthorized party may be limited in time to guess the activation code or log-in, and may be limited in a number of attempts to guess the activation code or log-in.

The particular authentication process(es) to be performed may be selected by the user, by the application provider computer 120, by the transaction processing computer 130, by the authorizing entity computer 150, or any interested party. Further, it is contemplated that additional authentication processes may be performed after the methods of FIGS. 2 and 3 to further authenticate the user if desirable.

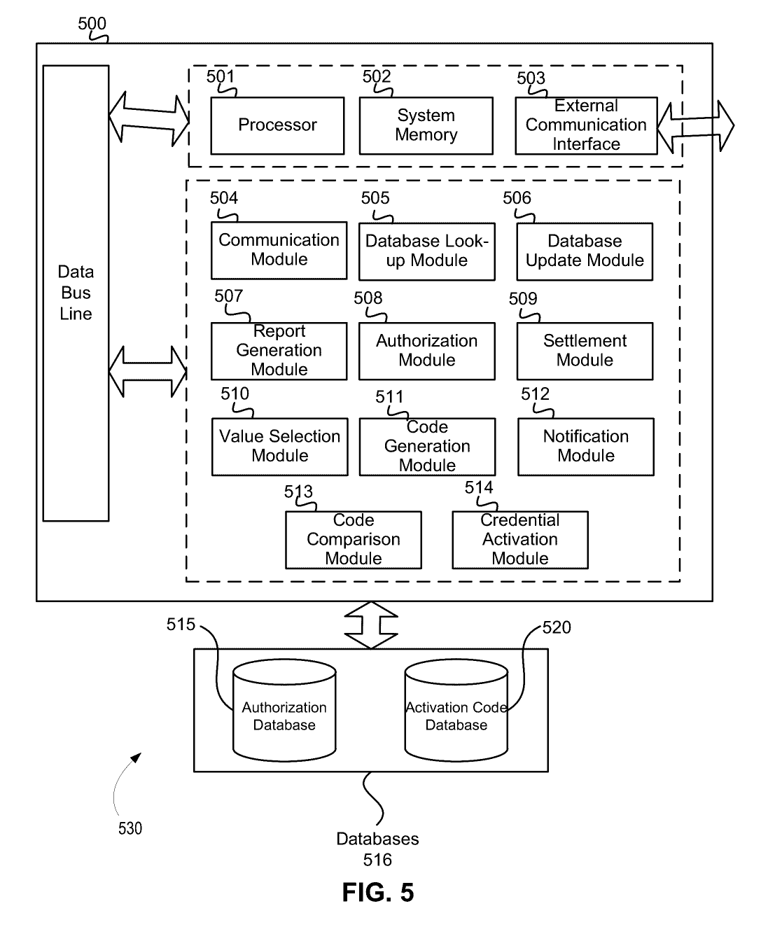

FIG. 5 shows a block diagram of a transaction processing computer 530 according to an embodiment of the present invention. Transaction processing computer 530 may be used to implement transaction processing computer 130 of FIGS. 1-3 and/or 6, for example. An exemplary server computer 500 in transaction processing computer 530 is shown. The server computer 500 is illustrated as comprising a plurality of hardware and software modules 501-514. However, it should be appreciated that this is provided for illustration purposes only, and each of the modules and associated functionality may be provided and/or performed by the same or different components. That is, server computer 500 may, for example, perform some of the relevant functions and steps described herein with reference to the transaction processing computer 530 through the use of any suitable combination of software instructions and/or hardware configurations. It should be noted that although FIG. 5 illustrates all of the modules located on a single device, the modules may alternatively be located on multiple devices. Moreover, a system for implementing the functionality described herein may have additional components or less then all of these components. Additionally, some modules may be located on other devices such as a remote server or other local devices that are functionally connected to the server computer component(s).

The exemplary server computer 500 is shown as comprising a processor 501, system memory 502 (which may comprise any combination of volatile and/or non-volatile memory such as, for example, buffer memory, RAM, DRAM, ROM, flash, or any other suitable memory device), and an external communication interface 503. Moreover, one or more of the modules 504-514 may be disposed within one or more of the components of the system memory 502, or may be disposed externally. As was noted above, the software and hardware modules shown in FIG. 5 are provided for illustration purposes only, and the configurations are not intended to be limiting. The processor 501, system memory 502 and/or external communication interface 503 may be used in conjunction with any of the modules described below to provide a desired functionality. Some exemplary modules and related functionality may be as follows.

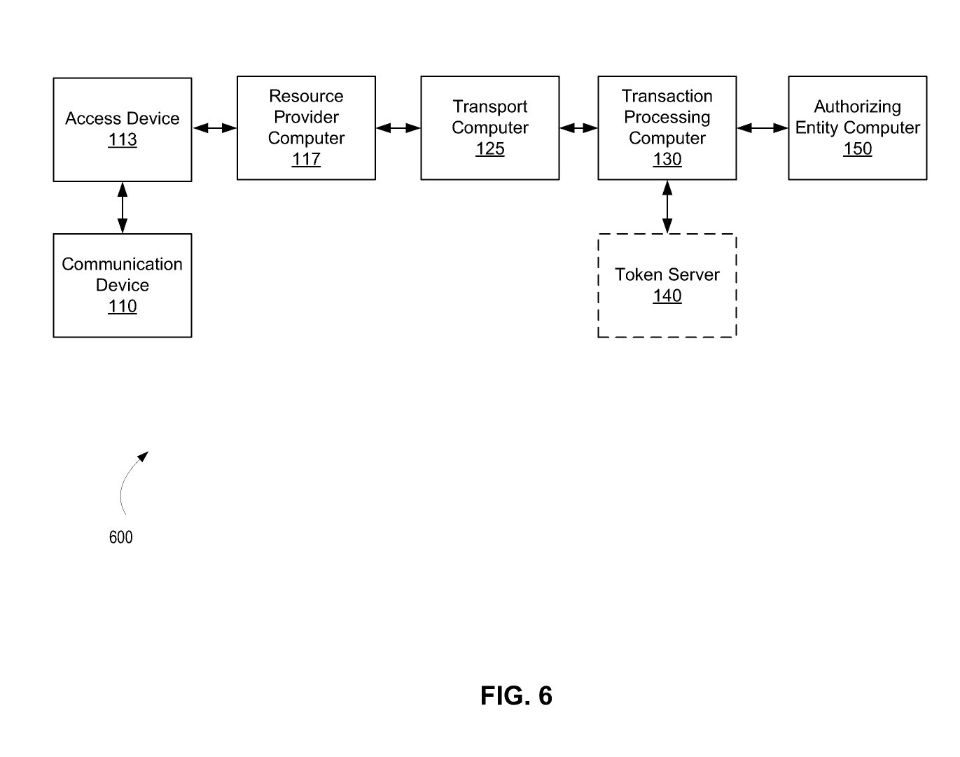

The communication module 504 may be configured or programmed to receive and generate electronic messages comprising information transmitted through the server computer 500 to or from any of the entities shown in FIGS. 1 and/or 6. When an electronic message is received by the server computer 500 via external communication interface 503, it may be passed to the communications module 504. The communications module 504 may, in conjunction with processor 501, identify and parse the relevant data based on a particular messaging protocol used in the server computer 500. The received information may comprise, for instance, identification information, transaction information, and/or any other information that the transaction processing computer 130 may utilize in authorizing a financial transaction or performing a settlement and clearing procedure. The communication module 504 may then, in conjunction with processor 501, transmit any received information to an appropriate module within the server computer 500 (e.g. via a data bus line). The communication module 504 may also, in conjunction with processor 501, receive information from one or more of the modules in server computer 500 and generate an electronic message in an appropriate data format in conformance with a transmission protocol used in a transaction system (e.g., authentication system 100 of FIG. 1 and/or transaction system 600 of FIG. 6) so that the message may be sent to one or more components within the system (e.g. to an authorizing entity computer). The electronic message may then be passed to the external communication interface 503 for transmission. The electronic message may, for example, comprise an authorization response message (e.g. to be transmitted to a merchant conducting a transaction) or may be an authorization request message to be transmitted or forwarded to an authorizing entity computer.

The database look-up module 505 may be programmed or configured to perform some or all of the functionality associated with retrieving information from one or more databases 516. In this regard, the database look-up module 505 may, in conjunction with processor 501, receive requests from one or more of the modules of server computer 500 (such as communication module 504, authorization module 508, or settlement module 509) for information that may be stored in one or more of the databases 516. The database look-up module 505 may then, in conjunction with processor 501, determine and a query an appropriate database. The database update module 506 may be programmed or configured to maintain and update the databases 516, such as authorization database 515. In this regard, the database update module 506 may, in conjunction with processor 501, receive information about a user, financial institution, a payment device, and/or current or past transaction information from one of the modules discussed herein. This information may then be stored in the appropriate location in the database 515 using any suitable storage process.

The report generation module 207 may be programmed or configured to perform some or all of the functionality associated with generating a report regarding a user, an account, a transaction or transactions, or any other entity or category of information with regard to an authentication or transaction system. This may include, for instance, identifying patterns (such as patterns that indicate a fraudulent transaction or transactions) and generating one or more alerts that may be sent (e.g. via communication module 504 and external communication interface 503) to one or more entities in the authentication or transaction system, including the user, the resource provider, or the authorizing entity. The report generation module may also, in conjunction with processor 501, request information from one or more of the databases 516 via database look-up module 505.

The authorization module 508 may be configured or programmed to perform some or all the functionality associated with authorizing a financial transaction associated with an authorization request message. The authorization request message may be associated with a transaction involving a credential. The authorization request message may include any suitable information that may be used to authorize or identify the transaction, and may be generated in response to an interaction. The authorization module 508 may, for instance, be programmed or configured to compare the information received by via the authorization request message with stored information at the server computer 500 or a database 515 (such as comprising verification values). In some embodiments, if the received and stored values match, the authorization module 508 may, in conjunction with processor 501, authorize the transaction (or may be more likely to authorize the transaction) and may instruct the communication module 501 to generate an authorization response message. The authorization module 507 may also be programmed or configured to execute any further operations associated with a typical authorization.

The value selection module 510 may, in conjunction with processor 501, select a value for a nominal transaction including an activation code, as described herein. The value may be a randomly selected amount, or can be selected according to any formula, algorithm or method. In one embodiment, the value is limited to a particular nominal range (e.g., $0.01 to $0.10). In one embodiment, the value is initially set as a first amount (e.g., $0.04) and is incremented each time an activation code is requested for a particular credential. For example, a first transaction may be run for $0.04. If the activation code is incorrectly provided by the user or the activation code expires, a second transaction may be run for $0.05. If the activation code is again entered incorrectly by the user or it expires, a third transaction may be run for $0.06, and so on and so forth.

The code generation module 511 may, in conjunction with processor 501, generate an activation code to be sent with a value as a transaction, as described further herein. The activation code may be any combination of letters, numbers and/or symbols, and may be of any suitable length. The activation code may be generated randomly, may be generated according to a formula or algorithm using any relevant data (e.g., a credential), or may be generated according to any other method.

The notification module 512 may, in conjunction with processor 501 and external communication interface 503, generate and send a notification message to a communication device associated with a user to retrieve an activation code and/or a value from the user's credential account. An exemplary notification message may state: “A transaction was sent to your card account. Please login and retrieve the activation code from your online banking statement.” The notification module 512 may further, in conjunction with processor 501 and external communication interface 503, generate notification messages to any interested entities regarding credential activation, as indicated by credential activation module 514.

The code comparison module 513 may, in conjunction with processor 501, compares a received activation code (i.e., entered by a user) to the activation code generated by code generation module 511. In one embodiment, the code comparison module 513 may further, in conjunction with processor 501, compare a received value (i.e., entered by a user) to the value generated by value selection module 510. The code comparison module 513 may further, in conjunction with processor 501, determine whether the activation code was received from the user within a prescribed time limit from being generated by code generation module 511.

The credential activation module 514 may, in conjunction with processor 501, activate a credential if the code comparison module 513 determines that the received activation code matches the activated code generated by code generation module 511. Activation may include marking the credential as active in a database so that it may be used to access resources (e.g., to conduct transactions). The credential activation module 514 may further, in conjunction with processor 501, instruct the notification module 512 to notify any interested parties (e.g., the authorizing entity, the application provider, the user, etc.) that the credential has been activated.

The transaction processing computer 530 may include one or more databases 516, such as authorization database 515 and activation code database 520. Each of the databases shown in this example may comprise more than one database, and may be located in the same location or at different locations. The authorization database 515 may contain information related to a credential and/or a payment account, as well as any other suitable information (such as transaction information) associated with the credential. For example, the authorization database 515 may comprise a relational database having a plurality of associated fields, including a primary account identifier (e.g. a PAN), an authorizing entity associated with the account, expiration date of a payment device, a verification value(s), an amount authorized for a transaction, a user name, user contact information, prior transaction data, etc. In some embodiments, the authorization module 508 may utilize some or all of the information stored in the authorization database 515 when authorizing a transaction.

The databases 516 may also comprise an activation code database 520. The activation code database 520 may store activation codes generated by code generation module 511, in association with the credential or some other identifier, to be compared to a received activation code. In some embodiments, the activation code database 520 may further store the generated activation codes in association with time limits during which the matching activation code must be received. If this time limit passes, or if the activation code is incorrectly entered by the user, the generated activation code may be marked as expired, and may no longer be used to activate or provision the associated credential.

FIG. 6 is a block diagram of a transaction system 600 for using an activated and/or provisioned credential for a payment transaction according to an embodiment of the present invention. After the communication device 110 is provisioned with the credential (e.g., PAN or token), or otherwise has access to the activated credential on the communication device 110, the communication device 110 can be used to conduct payment transactions. In some embodiments, the communication device 110 can be used at an access device 113 operated by a resource provider (e.g., a merchant). The access device 113 can receive the credential from the communication device 110, and the access device 113 or the resource provider computer 117 can generate and send an authorization request message to the transaction processing computer 130, optionally via a transport computer 125. When the credential includes a token, the transaction processing computer 130 may then contact the token server 140 to obtain the PAN associated with the token. After it obtains the PAN, the transaction processing computer 130 can generate and send a modified authorization request message with the PAN to an authorizing entity computer 150 for approval.

The authorizing entity computer 150 may then send an authorization response message with the PAN back to the transaction processing computer 130. The transaction processing computer 130 can contact the token server 140 to retrieve the token. The transaction processing computer 130 may then generate a modified authorization response message with the token and may forward this back to the access device 113 via the optional transport computer 125 and the resource provider computer 117. The access device 113 may optionally notify the communication device 110 of the transaction result.

At a later point in time (e.g., at the end of the day), a clearing and settlement process can be conducted between the transport computer 125, the transaction processing computer 130, and the authorizing entity computer 150. The resource provider computer 117 may first provide a file with the credential and the associated transaction data to the transport computer 125. The transport computer 125 may then transmit any clearing and settlement messages to the transaction processing computer 130 using the credential. If the credential is a token, the token may then be converted to the PAN as described above to facilitate the exchange of messages and the transfer of funds between the transport computer 125 and the authorizing entity computer 150.

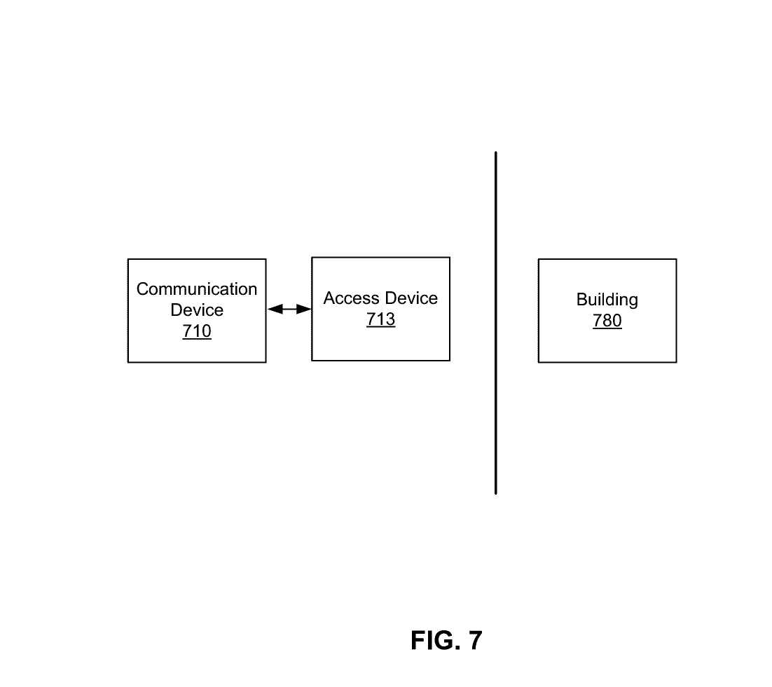

Authentication may be performed to activate or provision credentials outside of financial transaction contexts as well. For example, embodiments of the invention may be utilized to authenticate a user prior to activating or provisioning access credentials to a device. For example, FIG. 7 shows a block diagram of a building access system according to embodiments of the invention. A user activates or provisions access credentials to a communication device 710 as described herein with respect to FIGS. 2 and 3. Communication device 710 may comprise communication device 110, for example.

After the communication device 710 is provisioned with the credential (e.g., access rights), or otherwise has access to the activated credential on the communication device 710, the communication device 710 can be used to conduct access transactions using the credential. For example, communication device 710 can interact with access device 713 and pass the credential to access device 713. The access device 713 may locally analyze the credential to determine whether access should be granted to building 780, or it may communicate with a remotely located server computer (not shown). The remotely located server computer may analyze the credential to determine whether access should be granted to building 780, and may transmit a signal indicating this back to the access device 713. The access device 713 may then proceed to allow or deny access by the user of communication device 710 to the building 780, in accordance with the credential.

Embodiments of the invention may provide a number of advantages. First, no additional authorizing entity integration is required to implement this type of authentication. In addition, a code sent with a transaction may conventionally be carried in a transaction amount field. However, the transaction amount field may be too small to carry a desired activation code (e.g., six digits), since the charge may be for a nominal amount (e.g., under one dollar), limiting the number of digits for use (e.g., 3 digits).

According to embodiments of the invention, the activation code can be larger in size (e.g., have a greater number of characters), which provides additional security. Further, the merchant descriptor field allows for use of a variety of characters, as opposed to just numbers. Thus, the merchant descriptor field can support a code that can be generated from a greater number of possible combinations and permutations, which also provides additional security. Thus, embodiments of the invention enable support for an activation code that is more complex and that makes an authentication process more secure.

Additionally, embodiments of the invention enable an activation code to be sent using a single charge. This is more convenient for a user since only one activation code may be retrieved and entered by the user. Other cases utilizing a sequence of multiple charges to provide additional codes may create confusion for the user, for example, about the order of the charges. Further, it can be cumbersome for the user to retrieve and enter multiple codes.

The various participants and elements described herein may operate one or more computer apparatuses to facilitate the functions described herein. Any of the elements in the above-described figures, including any servers or databases, may use any suitable number of subsystems to facilitate the functions described herein.

Such subsystems or components are interconnected via a system bus. Subsystems may include a printer, keyboard, fixed disk (or other memory comprising computer readable media), monitor, which is coupled to display adapter, and others. Peripherals and input/output (I/O) devices, which couple to an I/O controller (which can be a processor or other suitable controller), can be connected to the computer system by any number of means known in the art, such as a serial port. For example, a serial port or an external interface can be used to connect the computer apparatus to a wide area network such as the Internet, a mouse input device, or a scanner. The interconnection via the system bus allows the central processor to communicate with each subsystem and to control the execution of instructions from system memory or the fixed disk, as well as the exchange of information between subsystems. The system memory and/or the fixed disk may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

For simplicity of illustration, a certain number of components are shown in FIGS. 1 and 5-7. It is understood, however, that embodiments of the invention may include more than one of each component. In addition, some embodiments of the invention may include fewer than or greater than all of the components shown in FIGS. 1 and 5-7. In addition, the components in FIGS. 1 and 5-7 may communicate via any suitable communication medium (including the Internet), using any suitable communications protocol.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer, a request to activate a credential, wherein the credential allows access to a resource by a user;
performing, by the server computer, a first authentication process of the user;
determining, by the server computer, that a second authentication process of the user is necessary;
performing, by the server computer, the second authentication process of the user, wherein the second authentication process comprises:
generating, by the server computer, an authorization request message comprising a value and an activation code;
sending, by the server computer, the authorization request message to an authorizing entity computer associated with the credential;
receiving, by the server computer, an authorization response message approving of the authorization request message;
sending, by the server computer, a notification message notifying the user to retrieve the activation code;
receiving, by the server computer, the activation code; and
determining, by the server computer, that the received activation code matches the generated activation code; and
after performing the second authentication process of the user, activating the credential.

2. The method of claim 1, wherein the credential is a token.

3. The method of claim 1, wherein activating the credential comprises provisioning the credential to a device operated by the user.

4. The method of claim 1, further comprising:
sending, by the server computer, an activation message notifying the user that the credential is activated.

5. The method of claim 1, wherein the activation code is received within a threshold time period after the notification message is sent.

6. The method of claim 1, wherein the authorization request message requests preauthorization for the value.

7. The method of claim 1, further comprising:
generating a second authorization request message requesting reversal of the value.

8. A server computer comprising:
a processor; and
a memory element comprising code, executable by the processor, for implementing a method comprising:
receiving a request to activate a credential, wherein the credential allows access to a resource by a user;
performing a first authentication process of the user;
determining that a second authentication process of the user is necessary;
performing the second authentication process of the user, wherein the second authentication process comprises:
generating an authorization request message comprising a value and an activation code;
sending the authorization request message to an authorizing entity computer associated with the credential;
receiving an authorization response message approving of the authorization request message;
sending a notification message notifying the user to retrieve the activation code;
receiving the activation code; and
determining that the received activation code matches the generated activation code; and
after performing the second authentication process of the user, activating the credential.

9. The server computer of claim 8, wherein the credential is a token.

10. The server computer of claim 8, wherein activating the credential comprises provisioning the credential to a device operated by the user.

11. The server computer of claim 8, wherein the method further comprises:
sending an activation message notifying the user that the credential is activated.

12. The server computer of claim 8, wherein the activation code is received within a threshold time period after the notification message is sent.

13. The server computer of claim 8, wherein the authorization request message requests preauthorization for the value.

14. The server computer of claim 8, wherein the method further comprises:
generating a second authorization request message requesting reversal of the value.
